(19) United States
(12) Patent Application Publication
(10) Pub. No.: US 2016/0150062 A1
(43) Pub. Date: May 26, 2016

(54) Protective film using strengthened glass for display screen

(71) Applicant: Weon phyo RHEE, Seoul (KR)

(72) Inventor: Weon phyo RHEE, Seoul (KR)

(21) Appl. No.: 14/555,450

(22) Filed: Nov. 26, 2014

(51) Int. Cl. H04M 1/02

(52) U.S. Cl. CPC H04M 1/0266

(57) ABSTRACT

A protective film using strengthened glass for display screen is provided, which includes a strengthened glass portion, a curved surface portion having a specific portion of a bottom surface formed with curved surface so as to correspond to a curved edge of the a display screen of a mobile device, formed with a gradual thickness from an end portion of the edge with a top portion formed with a curved surface, and insert-molded to the stepped latching portion of the strengthened glass portion so as to be connected to the edge of the strengthened glass portion, forming integrally with soft silicon material, and a sticking layer formed with the bottom surface of the strengthened glass portion with sticking material made of silicon material deposited below the strengthened glass portion.

### FIELD OF TECHNOLOGY

The invention relates to a protective film using strengthened glass for display screen, more specifically to a protective film using strengthened glass for protecting a display screen by attaching the protective film up to a curved surface, for edges of the display screen installed in the devices such as mobile phone are formed with curved surfaces.

### BACKGROUND OF INVENTION

In general, in mobile devices such as mobile phone (10), smart phone (10), etc., a protective film (30) is attached for protecting a display screen (20), preventing external shock and scratch, so as to help the device used cleanly or prevent the performance of the device from being compromised.

The display screen (20) of conventional mobile devices such as the mobile phone (10), smart phone (10), etc. was manufactured as a flat surface as shown in FIGS. 1 and 2, and thus the protective film (30) was attached to the display screen (20) entirely as the A region shown in FIG. 2, performing roles and functions as a protective film (30).

However, as the design of the mobile devices such as the mobile phone (10), smart phone (10), etc. changes gradually, ones with edges of the display screen (20) curved as shown in FIGS. 3 and 4.

Accordingly, with the conventional protective film (30), the edges of the protective film (30) could not be covered to the end portions as in the regions such as the lines with double dots in FIG. 3 or the region B in FIG. 4.

That is, in the case of attaching the protective film (30) to the display screen (20) up to the edges, the protective film (30) attached to the curved edge (22) is opened or detached easily while using the device, making the device look rugged, ruining the outlook, so as to cause complaints from the users, so that the protective film (30) could be attached just shy from the curved edge (22) as shown in FIG. 3.

Thus, the bare portions exposed between the lines with double dots and the curved edge (22) of the display screen (20) in FIG. 3 could not be free from external shock- or scratch-causing problems, being the weakest portion of the display screen (20), and therefore damages to the portion took place easily by the problems such as contamination, scratch, and external shock.

### DISCLOSURE OF INVENTION

### Problems to Solve

The invention is to solve the above problems, and when edges of the display screen of a mobile device such as mobile phone, smart phone, etc. are formed with round and curved surface, the invention is to protect the display screen by covering both flat and curved portions of the display screen, and especially the curved portion is covered by soft silicon material and the edges of the silicon material is configured not to be detached from the curved portion of the display screen, achieving protection of the entire display screen.

### Solutions to Problems

The above goals are achieved by a protective film using strengthened glass for display screen, the protective film comprising: a strengthened glass portion (102) comprising stepped latching portion (104)s formed on bottom portions of edges at four corners; a curved surface portion (106) having a specific portion of a bottom surface formed with curved surface so as to correspond to a curved edge (22) of the a display screen (20) of a mobile device (10), formed with a gradual thickness from an end portion of the edge with a top portion formed with a curved surface, and insert-molded to the stepped latching portion (104) of the strengthened glass portion (102) so as to be connected to the edge of the strengthened glass portion (102), forming integrally with soft silicon material; and a sticking layer (108) formed with the bottom surface of the strengthened glass portion (102) with sticking material made of silicon material deposited below the strengthened glass portion (102).

And, preferably the bottom surface of the curved surface portion (106) protrudes further downward than a bottom surface of the strengthened glass portion (102).

Also, preferably a top surface of the curved surface portion (106) is coated with a thin film of synthetic resin.

### Effects of Invention

The invention enables to read output displayed on the display screen of a mobile device such as mobile phone, smart phone, etc. clearly through a strengthened glass having increased strength and clarity, to use conveniently a touch-type display screen due to an excellent touch, and to protect the display screen from damages by external shock or scratch by covering round and curved surfaces of the display screen that could not be protected by conventional synthetic resin thin film protective film with a curved surface formed with silicon material.

### BRIEF DESCRIPTION OF DRAWINGS

FIG. 1 is a front view showing a smart phone adopting a flat display screen.

FIG. 2 is a bottom view of FIG. 1 showing a region to which a protective film is attached.

FIG. 3 is a front view showing a smart phone adopting a display screen formed with curved edges and showing a region to which the protective film is attached.

FIG. 4 is a bottom view of FIG. 3 showing a edge structure of the display screen and the region to which the protective film is attached.

FIG. 5 shows a protective film using strengthened glass attached to the display screen according to the invention.

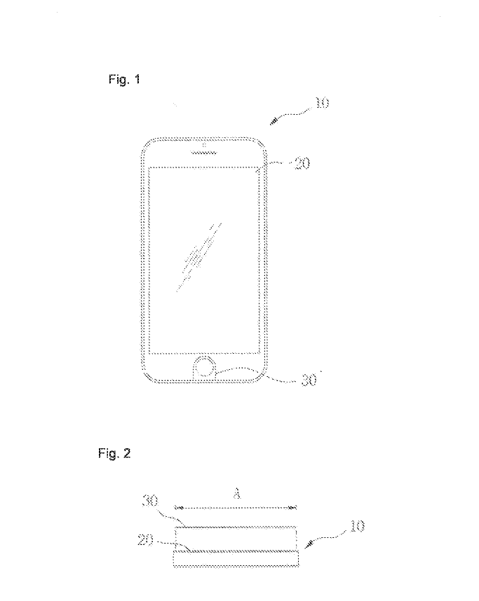

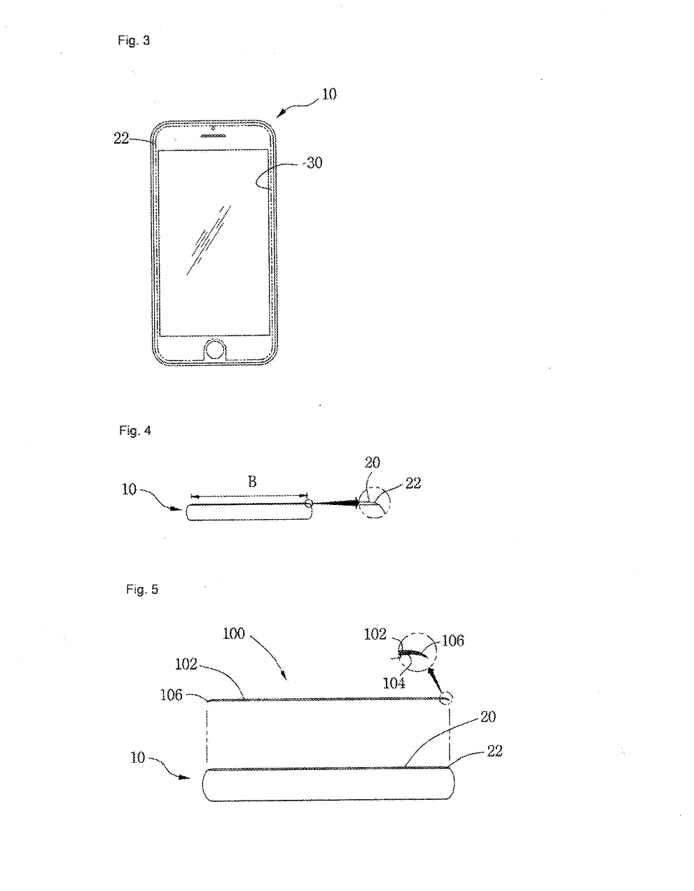

### DETAILED DESCRIPTION OF EMBODIMENTS OF INVENTION

The features and structures of the invention are described in detail below referring to FIG. 5.

A protective film using strengthened glass for display screen (100) comprises a strengthened glass portion (102), a curved surface portion (106), and a sticking layer (108), and the strengthened glass portion (102) is selected from a regular strengthened glass having increased hardness and clarity, covering a flat portion of the display screen (20).

On bottom portions of four corners of the strengthened glass portion (102), as shown in FIG. 5, are formed the stepped latching portion (104)s, and to each of the stepped latching portion (104)s is integrally formed the curved surface portion (106) insert-molded with soft silicon.

A specific portion of the bottom surface of the curved surface portion (106) is formed with a curved surface so as to correspond to the curved edge (22) of the display screen (20) used in the mobile device such as the mobile phone (10), smart phone (10), etc., and portions from the other portions to the stepped latching portion (104) are formed flatly.

Furthermore, the top surface of the curved surface portion (106) gets gradually thicker from the end portion of the edges as illustrated, and insert-molded so as to be connected to and integrated with the edge of the strengthened glass portion (102).

The curved surface portion (106) is formed with soft silicon material as described in the above, and since the curved surface portion (106) insert-molded with soft silicon material has a physical property of being sticky on the surface for itself, even when no sticking material is deposited on a bottom surface of the curved surface portion (106), slipping phenomenon does not take place, maintaining a state of being attached to the display screen (20).

On the contrary, since the top surface of the curved surface portion (106) is a portion exposed to outside such as user's hand or cloth, the top surface gets exposed to contamination by dust and the like when it maintains the physical property of silicon material.

Therefore, in the invention, preferably the top surface of the curved surface portion (106) is coated by a thin film of synthetic resin, so that the contamination by external environment be prevented in advance.

By the way, on the bottom surface of the strengthened glass portion (102) is deposited sticking material made of silicon material, forming the sticking layer (108), so as to be stuck to the flat surface of the display screen (20).

Here, the bottom surface of the curved surface portion (106) and the bottom surface of the strengthened glass portion (102) are configured to form stepped latching portions as shown in FIG. 5, and the bottom surface of the strengthened glass portion (102) is made to protrude more downwards than the bottom surface of the curved surface portion (106).

The reason that the bottom surface of the strengthened glass portion (102) protrudes more downwards than the bottom surface of the curved surface portion (106) as described in the above is that the curved surface portion (106) must be insert-molded to the strengthened glass portion (102) and the sticking layer (108) must be formed on the bottom surface of the strengthened glass portion (102) through a step of depositing the sticking layer (108) with a roller, in which the roller must contact the bottom surface of the strengthened glass portion (102) only without contacting the bottom surface of the curved surface portion (106), and since the step difference is so minute that the gap due to the step difference is not recognizable when the strengthened glass portion (102) and the curved surface portion (106) are attached closely to the display screen (20).

As discussed in the above, when edges of the display screen of a mobile device such as mobile phone, smart phone, etc. are formed with round and curved surface, the invention is to protect the display screen by covering both flat and curved portions of the display screen.

### REFERENCE NUMERALS

100: protective film using strengthened glass
102: strengthened glass portion
104: stepped latching portion
106: curved surface portion
108: sticking layer

1. A protective film using strengthened glass for display screen, the protective film comprising:
a strengthened glass portion (102) comprising stepped latching portion (104)s formed on bottom portions of edges at four corners;
a curved surface portion (106) having a specific portion of a bottom surface formed with curved surface so as to correspond to a curved edge (22) of the a display screen (20) of a mobile device (10), formed with a gradual thickness from an end portion of the edge with a top portion formed with a curved surface, and insert-molded to the stepped latching portion (104) of the strengthened glass portion (102) so as to be connected to the edge of the strengthened glass portion (102), forming integrally with soft silicon material; and
a sticking layer (108) formed with the bottom surface of the strengthened glass portion (102) with sticking material made of silicon material deposited below the strengthened glass portion (102).

2. The protective film using strengthened glass for display screen of claim 1, wherein a bottom surface of the curved surface portion (106) protrudes further downward than a bottom surface of the strengthened glass portion (102).

3. The protective film using strengthened glass for display screen of claim 2, wherein a top surface of the curved surface portion (106) is coated with a thin film of synthetic resin.

4. The protective film using strengthened glass for display screen of claim 1, wherein a top surface of the curved surface portion (106) is coated with a thin film of synthetic resin.
